(19) United States
(12) Patent Application Publication
(10) Pub. No.: US 2007/0145154 A1
(43) Pub. Date: Jun. 28, 2007

(54) INTERFACE FOR A REMOVABLE ELECTRICAL CARD

(75) Inventors: Gordon Yu, Taipei County (TW); Chung Liang Lee, Taipei City (TW); Chih-Yuan Liu, Hsinchu County (TW); Chanson Lin, Hsinchu County (TW); Hsiang-An Hsieh, Taipei County (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignees: ASUSTEK COMPUTER INCORPORATED, Taipei (TW); CARRY COMPUTER ENGINEERING CORP., LTD., Taipei (TW); C-ONE TECHNOLOGY CORP., Hsinchu (TW); INDUSTRIAL TECHNOLOGY RESEARCH INSTITUTE, Hsinchu (TW); INNODISK CORPORATION, Taipei (TW); POWER DIGITAL CARD CO., LTD., Taipei (TW); PROLIFIC TECHNOLOGY, INC., Taipei City (TW)

(21) Appl. No.: 11/426,706

(22) Filed: Jun. 27, 2006

Related U.S. Application Data
(60) Provisional application No. 60/753,328, filed on Dec. 22, 2005.

(51) Int. Cl. G06K 19/06; G06K 7/06

(52) U.S. Cl. 235/492; 235/441

(57) ABSTRACT

A removable electrical interface device for transferring data to and from a host adapted to operate in one of a universal serial bus (USB) compatible mode, a Mu mode and a non-USB compatible mode includes a first row of contact pads capable of supporting at least one of USB Standard-A connection, Mu mode connection or non-USB compatible mode connection, and a second row of contact pads capable of supporting the Mu mode connection and the non-USB compatible mode connection.

### CROSS-REFERENCE TO RELATED APPLICATIONS

This application claims the benefit of U.S. Provisional Application No. 60/753,328, filed Dec. 22, 2005, which is herein incorporated by reference in its entirety.

### FIELD OF THE INVENTION

The present invention relates generally to a removable electronic device and, more particularly, to a removable electrical interface device and method of operating or detecting a removable electrical interface.

### BACKGROUND OF THE INVENTION

A memory card is commonly known as a small portable package containing digital memory, such as an array of non-volatile memories like flash memories, EPROMs, or EEPROMs (electrically erasable and programmable read only memory). Memory cards have gained popularity as a device for storing a substantial amount of bytes of data from personal computers, notebook computers, personal electronic assistants, cellular telephones, cameras and other electronic devices that support removable data storage.

In general, a memory card includes exposed electrical contacts on its surface to allow easy connection to and removal from a receptacle of a host electronic system or device, particularly portable devices. A number of standards for a memory card have been implemented, including the MultiMedia Card (“MMC”) by the MultiMedia Card Association (“MMCA”) of Cupertino, Calif., and the Secure Digital (“SD”) card by the Secure Digital Card Association (“SDA”). An MMC card is a compact, removable memory card for storing and retrieving digital information in small, low power devices. MMC has been used in many mobile electronic applications, such as music players, mobile phones, personal digital assistants (PDAs), digital cameras, voice recorders, and GPS navigation devices. An SD card is a flash memory card, which has been used in portable devices like digital cameras and handheld computers.

Another known standard for a removable memory card, although not limited to memory storage, is the Universal Serial Bus (“USB”). USB is a high-speed serial bus that supports devices such as printers, keyboards, scanners, pointing devices, and PDAs. USB has become a standard within the computer industry as this protocol affords networking of multiple devices with minimal connections and increased user friendliness. USB is currently defined by the Universal Serial Bus Specification, written and controlled by USB Implementers Forum, Inc., a non-profit corporation founded by a group of companies that developed the USB specification. The specification covers all aspects of USB operations, including electrical, mechanical, and communications characteristics and specifications. One significant feature of the USB is that it allows a peripheral device to store information about itself, and to provide such information upon request by the host. This obviates the need for the host, be it a computer, operating system, or application program, to maintain this information for many different devices. Instead, the device itself stores and provides the information.

In the evolution of memory cards, there is a need for memory cards that consume low power and provide higher accessing speed, while retaining backward compatibility with existing protocols such as the MMC, SD and USB specifications.

### BRIEF SUMMARY OF THE INVENTION

A novel removable memory card standard is disclosed. The standard of the present invention includes both detection schemes and hardware interface compatibility requirements. Furthermore, the novel standard is backward compatible with the MMC, SD and USB applications.

In accordance with an embodiment of the present invention, there is provided a removable electrical interface device for transferring data to and from a host adapted to operate in one of a universal serial bus (USB) compatible mode, a Mu mode and a non-USB compatible mode that comprises a first row of contact pads capable of supporting at least one of USB Standard-A connection, Mu mode connection or non-USB compatible mode connection, and a second row of contact pads capable of supporting the Mu mode connection and the non-USB compatible mode connection.

Still in accordance with the present invention, there is provided a removable electrical interface device for transferring data to and from a host adapted to operate in one of a universal serial bus (USB) compatible mode, a Mu mode and a non-USB compatible mode that comprises an electrical card further comprising a first row of contact pads being connectible to or removable from a USB Standard-A receptacle of the host capable of supporting at least one of USB Standard-A connection, Mu mode connection or non-USB compatible mode connection, and a second row of contact pads capable of supporting the Mu mode connection and the non-USB compatible mode connection, and a carrier for supporting the electrical card.

Yet still in accordance with the present invention, there is provided a removable electrical interface device for transferring data to and from a host adapted to operate in one of a universal serial bus (USB) compatible mode, a Mu mode and a non-USB compatible mode that comprises an adapter further comprising a first row of contact pads capable of supporting at least one of USB Standard-A connection, Mu mode connection or non-USB compatible mode connection, and a second row of contact pads capable of supporting the Mu mode connection and the non-USB compatible mode connection, a first terminal being connectible to or removable from a USB Standard-A receptacle of the host, and a second terminal capable of receiving a memory card.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the present invention and together with the description, serves to explain the principles of the invention.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIGS. 1A, 1B and 1C are functional block diagrams of general applications of an electrical interface device in accordance with one embodiment of the present invention;

FIG. 2 is a functional block diagram of the general applications of an electrical interface device in accordance with another embodiment of the present invention;

FIGS. 3A to 3D are diagrams of electrical interface devices in accordance with embodiments of the present invention;

FIG. 4A is a pin arrangement of an electrical interface device in accordance with one embodiment of the present invention;

FIG. 4B is a pin assignment chart of the electrical interface device illustrated in FIG. 4A;

FIG. 5A is a pin arrangement of an electrical interface device in accordance with another embodiment of the present invention;

FIG. 5B is a pin assignment chart of the electrical interface device illustrated in FIG. 5A;

FIG. 6A is a pin assignment of an electrical interface device in accordance with still another embodiment of the present invention;

FIG. 6B is a pin assignment chart of the electrical interface device illustrated in FIG. 6A;

FIG. 7A is a diagram of an electrical interface device in accordance with one embodiment of the present invention;

FIG. 7B is a diagram of an electrical interface device in accordance with another embodiment of the present invention;

FIG. 7C is a diagram of an adapter for use with the electrical interface device illustrated in FIG. 7A in accordance with one embodiment of the present invention;

FIG. 7D is a diagram of an adapter for use with the electrical interface device illustrated in FIG. 7A in accordance with another embodiment of the present invention;

FIG. 8A is a schematic diagram of an electrical interface device in accordance with one embodiment of the present invention;

FIG. 8B is a schematic top elevational view of a micro memory card suitable for use with the electrical interface device illustrated in FIG. 8A;

FIG. 9 is a diagram of an electrical interface device in accordance with another embodiment of the present invention;

FIG. 10A is a diagram of an electrical interface device in accordance with still another embodiment of the present invention;

FIGS. 10B and 10C are functional block diagrams of the electrical interface device illustrated in FIG. 10A;

FIG. 11 is a flow diagram illustrating a method for interface mode detection at a device side; and

FIG. 12 is a flow diagram illustrating a method for interface mode detection at a host side.

### DETAILED DESCRIPTION OF THE INVENTION

In this detailed description, for purposes of explanation, numerous specific details are set forth to illustrate embodiments of the present invention. One skilled in the art will appreciate, however, that embodiments of the present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of embodiments of the present invention.

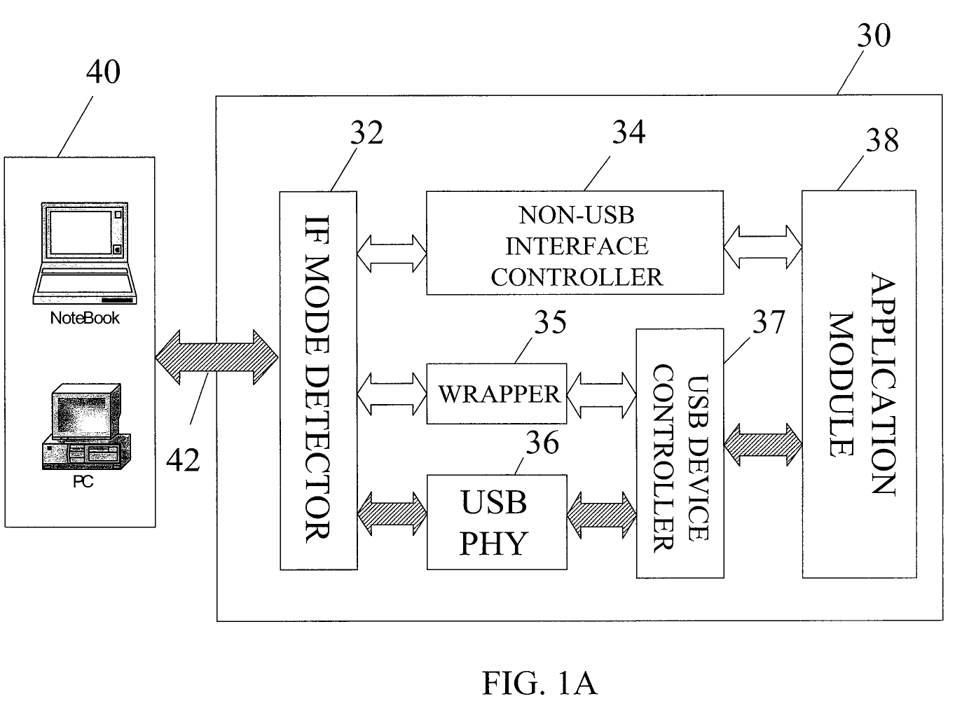

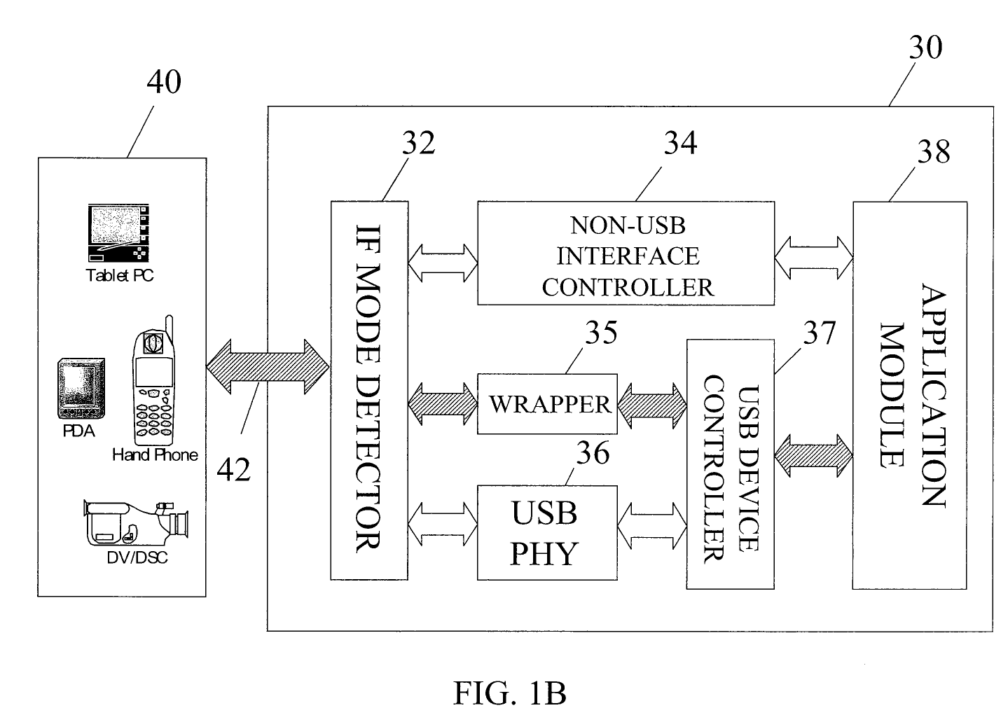

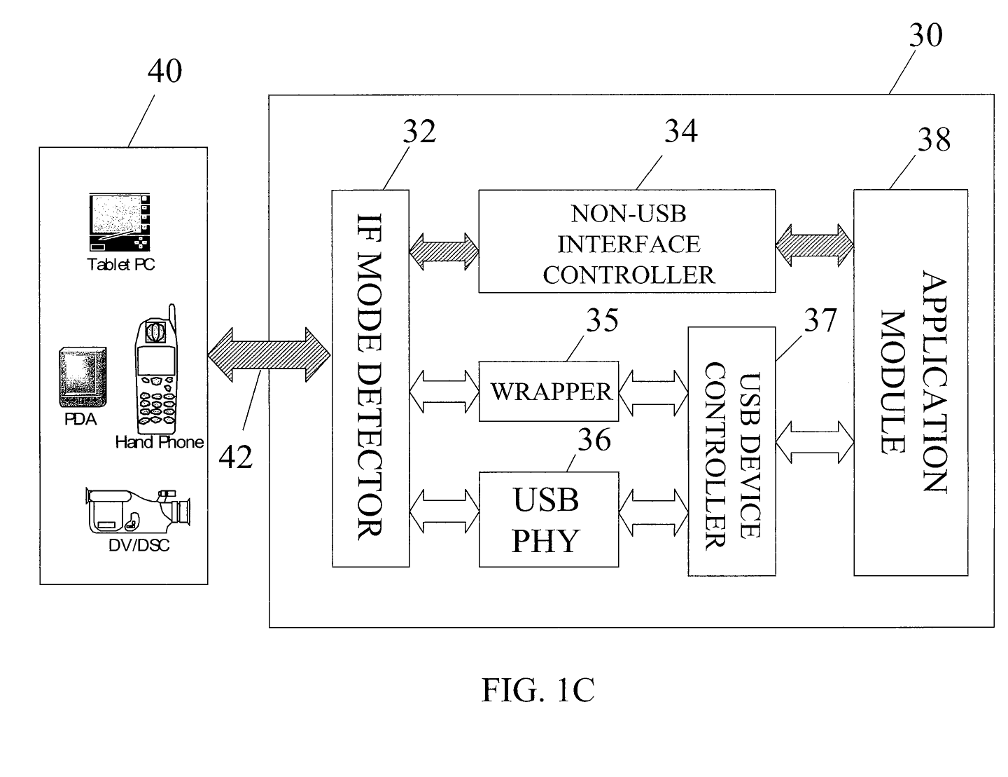

FIGS. 1A, 1B and 1C are functional block diagrams of general applications of a removable electrical interface device 30 in accordance with one embodiment of the present invention. Electrical interface device 30 is able to support several modes of operations, such as those compatible with USB applications, at least one of non-USB applications, including MMC, CF (compact flash), SM (smart media) and SD (security digital) applications, and Mu applications. A Mu application refers to a digital-parallel USB bus, which supports a low-power interface for mobile applications. The Mu card device and interface have been disclosed in U.S. patent application Ser. No. 11/190,233, entitled “Removable Electronic Device and Method Thereof”, filed Jul. 27, 2005, and U.S. patent application Ser. No. 11/190,230, entitled “Interface for a Removable Electronic Device”, filed Jul. 27, 2005, which are herein incorporated by reference. The USB compatible mode, for example, includes USB 2.0 application, and the MMC compatible mode includes one of MMC 4.0 or MMC SPI (serial-peripheral interface) applications.

The electrical interface device 30 includes a 1-, 4-, 8- or 16-bit interface, and provides low voltage support of 5V/3.3V/1.8V, with zero power consumption during standby. In addition, electrical interface device 30 is able to support a wide bandwidth from approximately 50 KB/sec to 120 MB/sec. In contrast, MMC 4.0 supports 1-, 4- or 8-bit data transfer at a maximum speed of 52 MB/sec, and USB 2.0 supports data transfer at a maximum speed of 60 MB/sec. Consequently, electrical interface device 30 provides high-speed applications while retaining backward compatibility with at least USB, MMC and MMC SPI applications.

FIG. 1A is a functional block diagram of electrical interface device 30 operating at a USB mode. Referring to FIG. 1A, electrical interface device 30 includes an interface (IF) mode detector 32, a non-USB interface controller 34, a wrapper 35, a universal serial bus (USB) physical layer (PHY) circuit 36, a USB device controller 37, and an application module 38. IF mode detector 32 detects a mode of operation to distinguish among a non-USB mode, a USB mode, or a Mu mode when electrical interface device 30 is inserted into a host 40. Host 40, for example, a notebook, a personal computer (PC), a cell phone, a tablet PC, a PDA or a DV/DSC, may include a card reader (not shown) for receiving electrical interface device 30. In the present embodiment, IF mode detector 32 detects whether a host 40, to which electrical interface device 30 is connected, is in compliance with the USB specifications. USB device controller 37 controls data transfer over a common bus 42 between host 40 and application module 38 via USB PHY circuit 36. Application module 38 functions to serve as a memory storage or an input/output (I/O) interface, depending on the operation mode detected.

FIG. 1B is a functional block diagram of electrical interface device 30 operating at a Mu mode. Referring to FIG. 1B, IF mode detector 32 detects whether a host 40, to which electrical interface device 30 is connected, is in compliance with the Mu specifications. USB device controller 37 controls data transfer between host 40 and application module 38 via wrapper 35. Wrapper 35, which wraps a call to a function or program inside another function or program, functions to convert 16-bit data into serial data recognizable by USB device controller 37, or vice versa. As such, wrapper 35 functions to bridge between a Mu bus and a UTMI (USB 2.0 Transceiver Macrocell Interface) bus. UTMI, which has been developed to define the interface specifications of the physical layer circuits and part of the logical layer circuits of the USB 2.0, enables a data transfer rate of 480 Mbps in high speed (HS) mode, which is significantly higher than that of the USB 1.1, while maintains backward compatibility with the USB 1.1 standard.

FIG. 1C is a functional block diagram of electrical interface device 30 operating at a non-USB mode. Referring to FIG. 1C, IF mode detector 32 detects whether a host 40, to which electrical interface device 30 is connected, is in compliance with one of the non-USB specifications. The non-USB interface controller 34 controls data transfer between host 40 and application module 38. The non-USB application includes but is not limited to one of MMC 4.0, a 1-, 4- or 8-bit interface, and MMC SPI, a 1-bit interface.

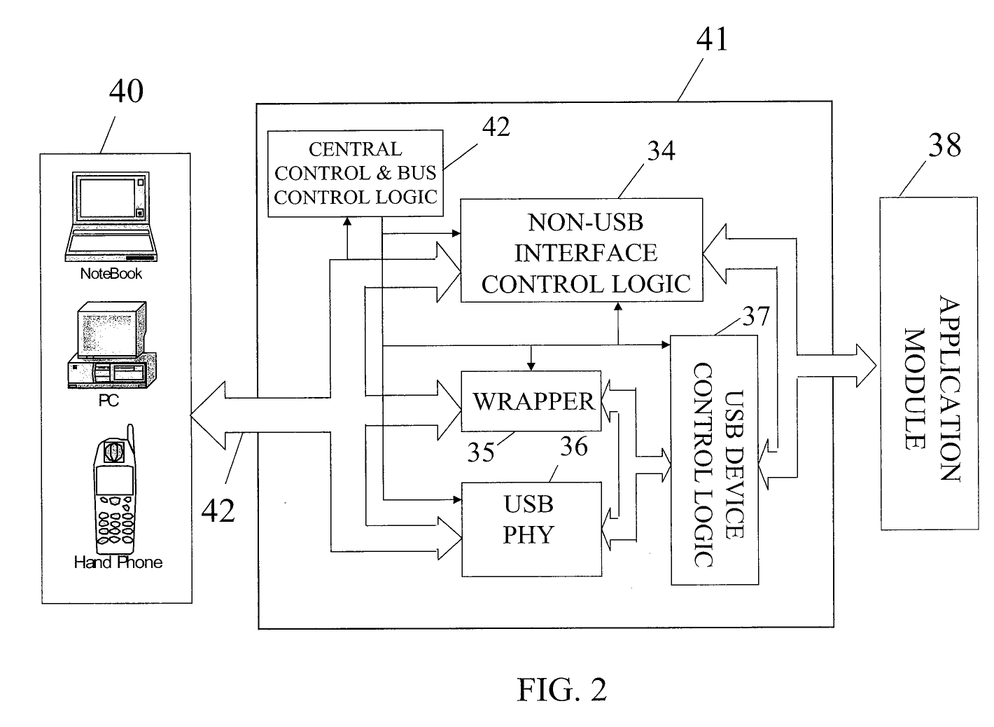

FIG. 2 is a functional block diagram of general applications of an electrical interface device 41 in accordance with another embodiment of the present invention. Referring to FIG. 2, electrical interface device 41 controls data transfer between host 40 and application module 38. Electrical interface 41 includes a similar structure to electrical interface device 30 illustrated in FIGS. 1A, 1B and 1C except that IF mode detector 32 is eliminated and a control unit 42 is added. Control unit 42 further includes a central control logic (not shown) for controlling system operations such as data and command transmission. Control unit 42 also includes a bus control logic (not shown) for selecting one of non-USB interface controller 34, wrapper 35 and USB PHY circuit 36 for communicating with host 40 over common bus 42.

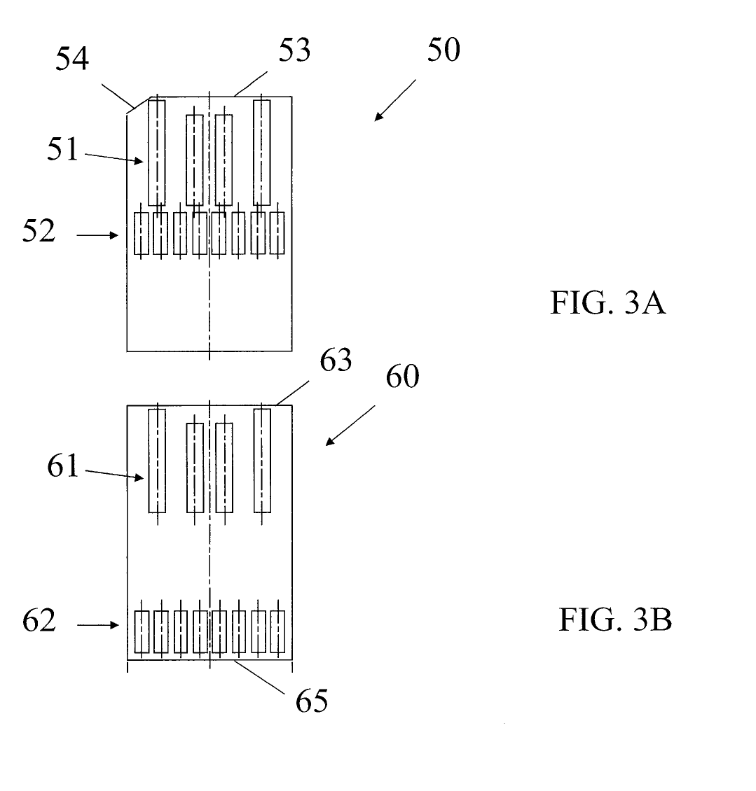

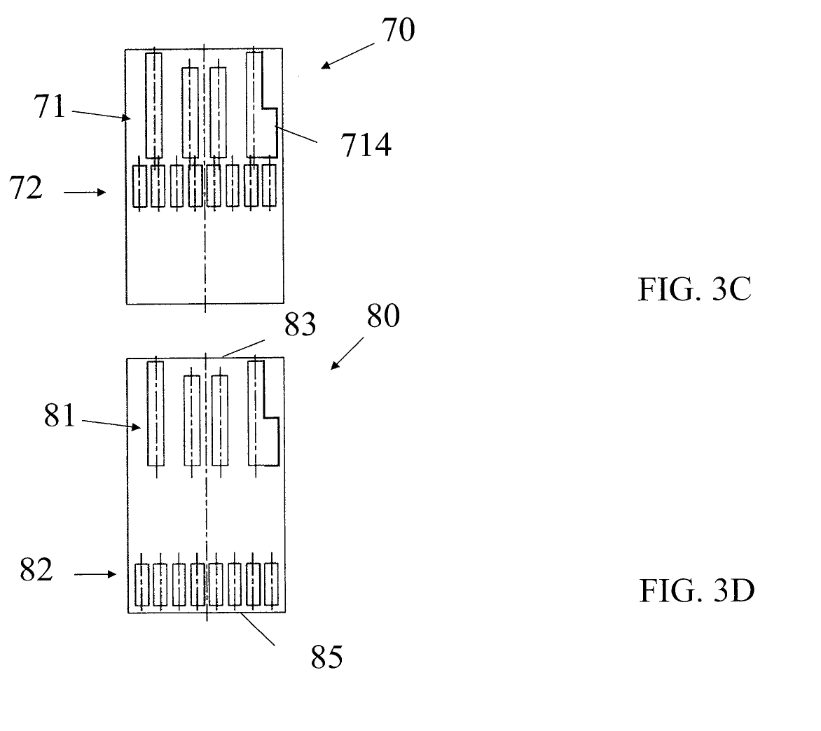

FIGS. 3A to 3D are diagrams of electrical interface devices in accordance with embodiments of the present invention. An electrical interface device according to the present invention is compatible with the USB Standard-A for connection with and removable from a USB Standard-A receptacle. USB connectors may be generally classified as Standard-A and Standard-B connectors. A Standard-A plug is oriented upstream towards a host system, while a Standard-B plug is oriented downstream towards a USB device. A Standard-A receptacle is downstream output from a USB host or hub, while a Standard-B receptacle is upstream input to a USB device or hub.

Referring to FIG. 3A, an electrical interface device 50 includes a first row of contact pads 51 and a second row of contact pads 52. The first row of contact pads 51, disposed near one side 53 of electrical interface device 50, is provided for connection with or removable from a USB Standard-A receptacle at one side 53. The second row of contact pads 52, disposed close to the first row of contact pads 51, is provided for the Mu interface or the non-USB interface communications. The second row of contact pads 52 supports a 4- or 8-bit bus in an interleaving format. The electrical interface device 50 includes a notch 54 on the upper left-hand corner to prevent incorrect insertion of the electrical interface device 50. Alternatively, the electrical interface device 50 includes a notch on the upper right-hand corner to prevent incorrect insertion.

Referring to FIG. 3B, an electrical interface device 60 has a similar structure to the electrical interface device 50 shown in FIG. 3A, except that a second row of contact pads 62 is disposed at another side 65 of electrical interface device 60. With a first row of contact pads 61 disposed at one side 63 and a second row of contact pads 62 disposed at another side 65, electrical interface device 60 is allowed to connect to a host device at either side 63 or side 65.

Referring to FIG. 3C, an electrical interface device 70 has a similar structure to the electrical interface device 50 shown in FIG. 3A, except that a contact pad 714 of a first row of contact pads 71 has a larger area to facilitate card detection. In one embodiment according to the present invention, contact pad 714 is electrically grounded or connected to a reference voltage level, and is pulled high when electrical interface device 50 is inserted into a host.

Referring to FIG. 3D, an electrical interface device 80 has a similar structure to the electrical interface device 70 shown in FIG. 3C, except that a second row of contact pads 82 is disposed at another side 85 of electrical interface device 80. With a first row of contact pads 81 disposed at one side 83 and a second row of contact pads 82 disposed at another side 85, electrical interface device 80 is allowed to connect to a host device at either side 83 or side 85.

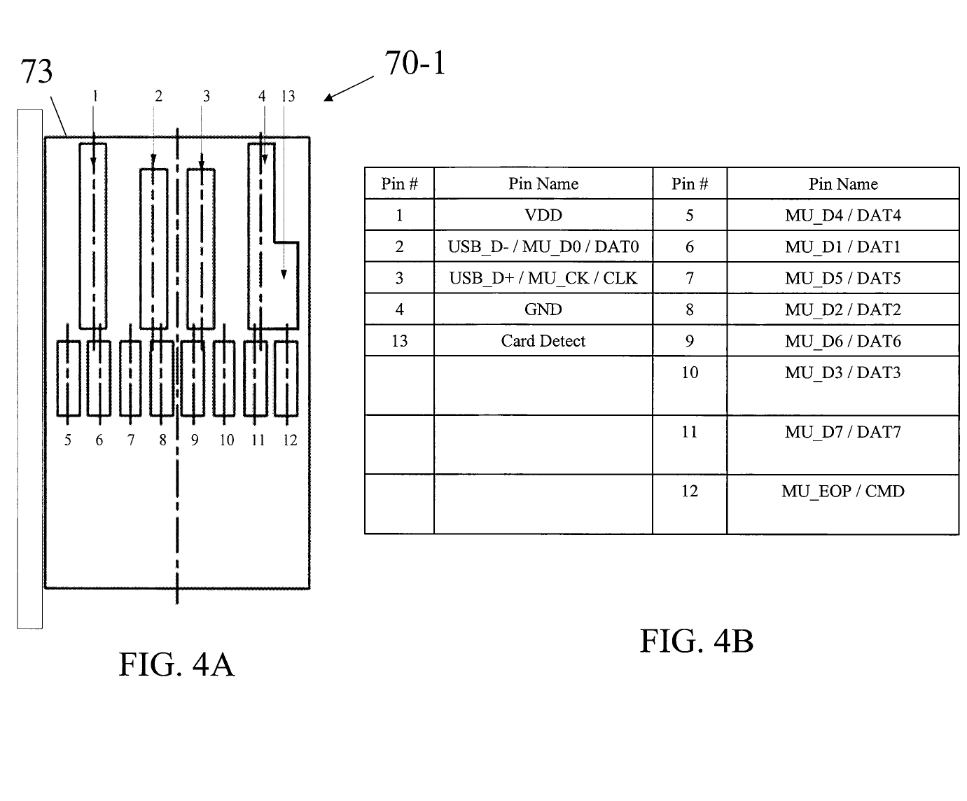

FIG. 4A is a pin layout of an electrical interface device 70-1 in accordance with one embodiment of the present invention. Referring to FIG. 4A, the electrical interface device 70-1, having a similar structure to electrical interface device 70 illustrated in FIG. 3C, includes a first row of pins with pin numbers 1 to 4 and 13 for the USB Standard-A interface communications, and a second row of pins with pin numbers 5 to 12 for the Mu and the non-USB interface communications.

FIG. 4B is a pin assignment chart of the electrical interface device 70-1 illustrated in FIG. 4A. Referring to FIG. 4B, the pin numbered 4 is electrically grounded or connected to a reference voltage level. The pin numbered 13, which is incorporated with the pin numbered 4 in a contact pad, serves as a card detection pin to identify the Mu interface mode or the non-USB interface mode. In one embodiment according to the present invention, a command format for the non-USB interface mode, for example, an MMC interface mode, is “40h, 00h, 00h, 00h, 00h, 95h”, while a command format for the Mu interface mode is one different from the MMC command format. The pin numbered 4 is disposed closer to a side 73 of the electrical interface device 70-1 than the pin numbered 13 such that the voltage level of the pin numbered 13 is not pulled high until electrical interface device 70-1 is inserted to a host from side 73.

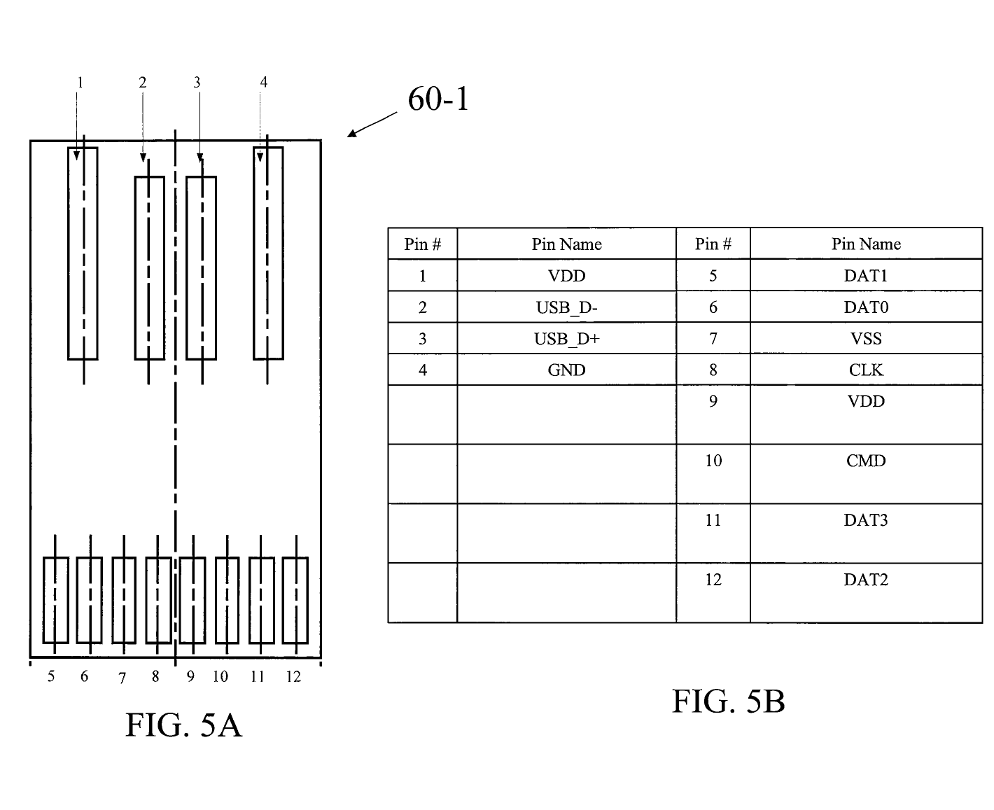

FIG. 5A is a pin arrangement of an electrical interface device 60-1 in accordance with another embodiment of the present invention. FIG. 5B is a pin assignment chart of the electrical interface device 60-1 illustrated in FIG. 5A. Referring to FIG. 5A, the electrical interface device 60-1 includes a similar structure to electrical interface device 60 illustrated in FIG. 3B. Referring to FIG. 5B, the electrical interface device 60-1 includes a first row of pins with pin numbers 1 to 4 for the USB Standard-A interface communications, and a second row of pins with pin numbers 5 to 12 for the Mu and the non-USB interface communications.

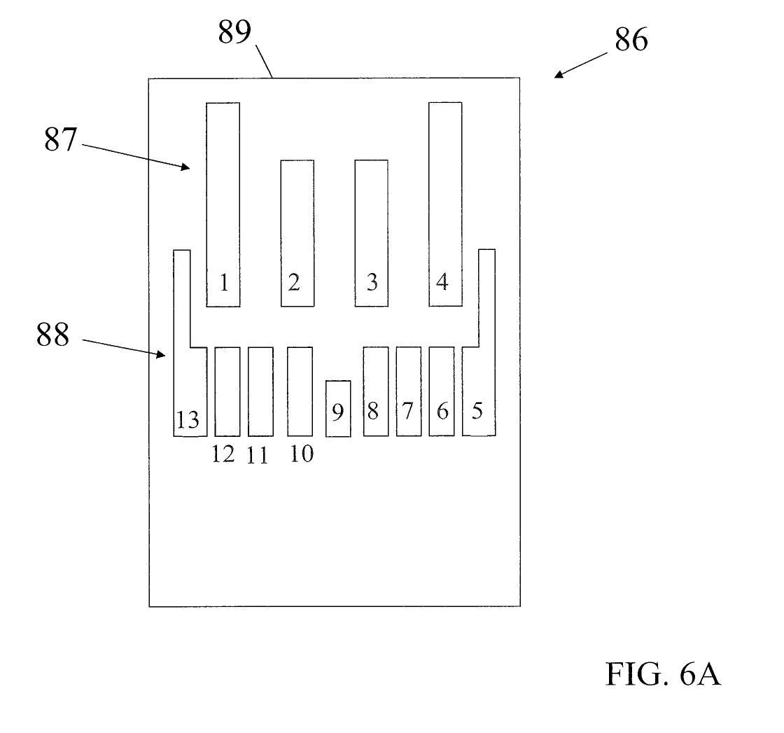

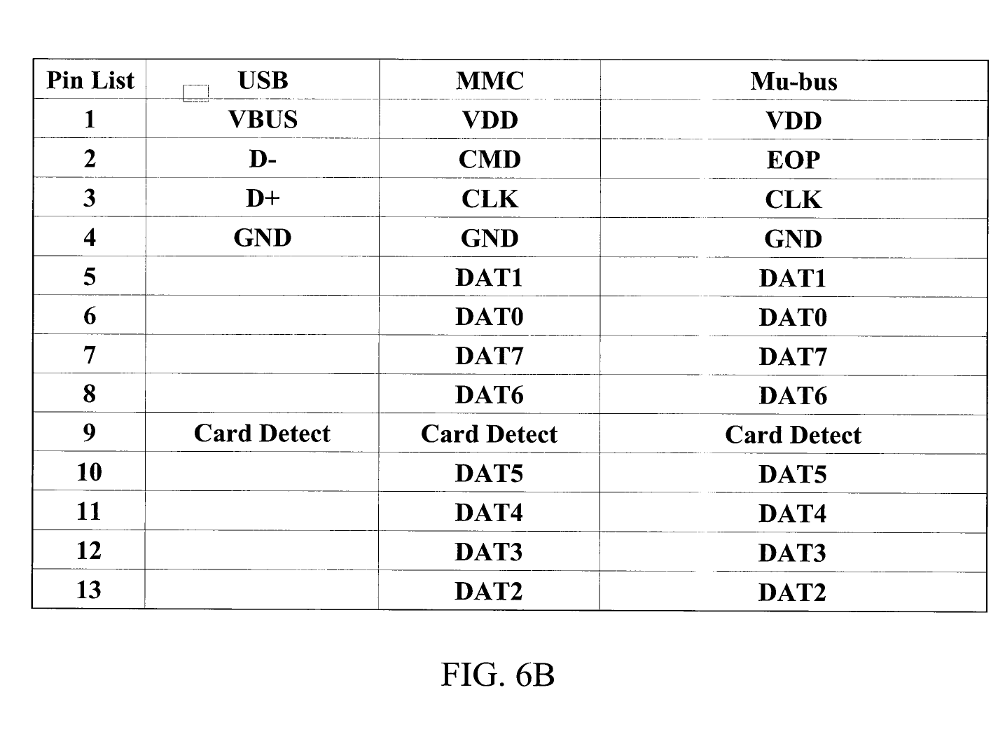

FIG. 6A is a pin arrangement of an electrical interface device 86 in accordance with one embodiment of the present invention. FIG. 6B is a pin assignment chart of the electrical interface device 86 illustrated in FIG. 6A. Referring to FIG. 6A, the electrical interface device 86 includes a first row of pins 87 including pins numbered 1 to 4 for the USB Standard-A interface communications, and a second row of pins 88 including pins numbered 5 to 13 for the Mu and the non-USB interface communications. Pins 13 and 5 of the second row of pins 88 extend toward a side 89 of electrical interface device 86 to exceed one ends (not numbered) of pins 1 and 4 of first row of pins 87, respectively. The extending portions of pins 13 and 5 may improve signal shielding for electrical interface device 86. Pin 9, also referring to FIG. 6B, serves as a card detection pin. Pin 9 is disposed further than other pins of the second row of pins 88 to side 89 such that pin 9 is the last pin to electrically contact a host when electrical interface device 86 is inserted into the host. As a result, electrical interface device 86 is not powered on and therefore will not be destroyed by a power-on voltage if electrical interface device 86 is incorrectly inserted to the host.

Referring to FIG. 6B, the first row of pins 1 to 4 not only supports the USB Standard-A connection when electrical interface device 86 illustrated in FIG. 6A operates in the USB mode, but also supports the Mu mode and non-USB mode connection when electrical interface device 86 operates in the Mu mode and the non-USB mode, respectively.

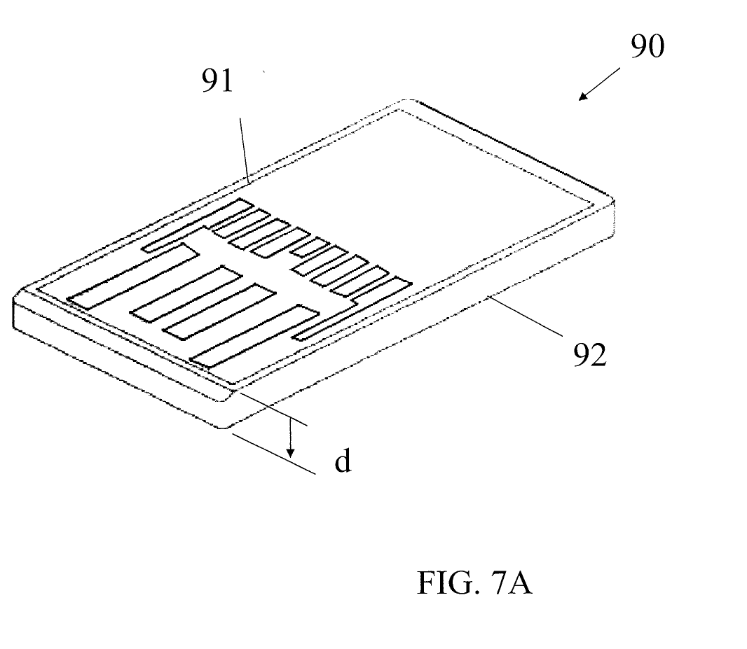

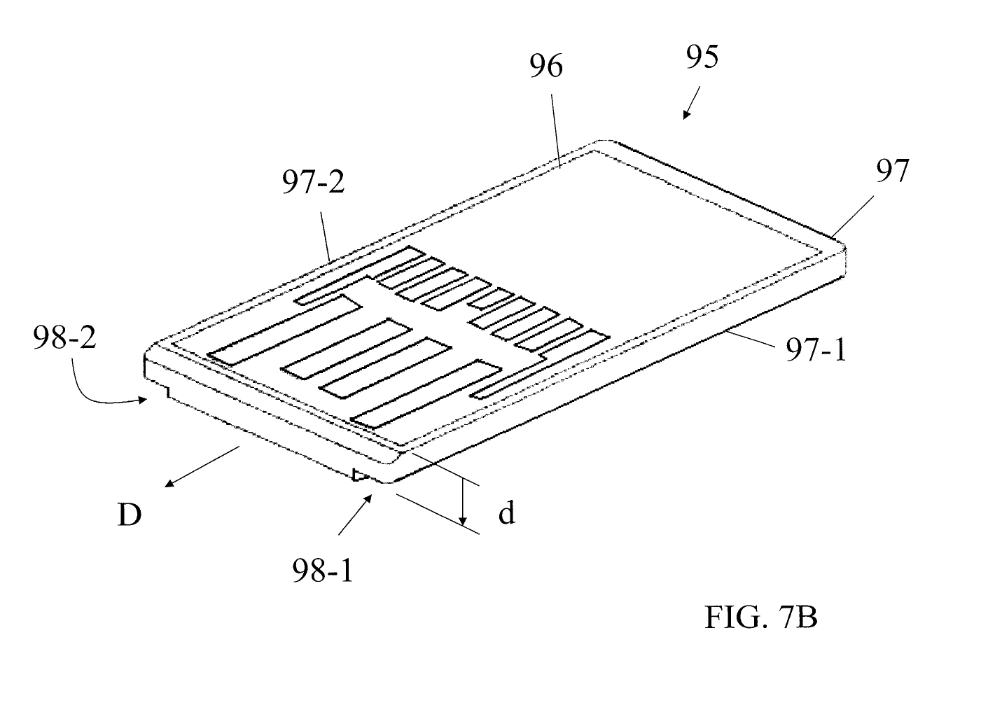

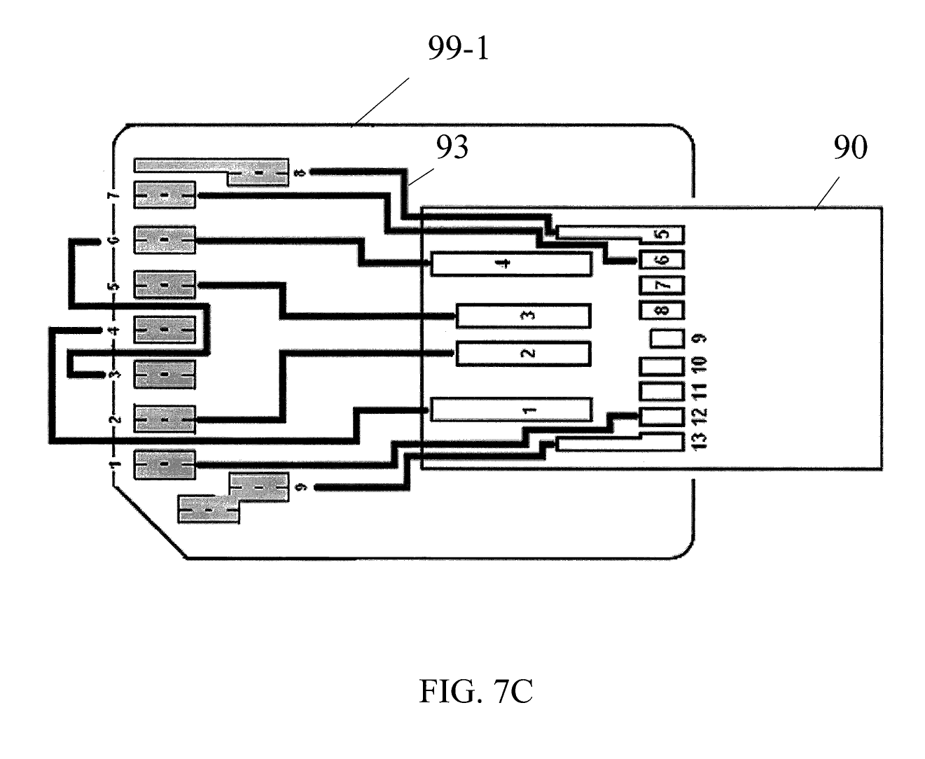

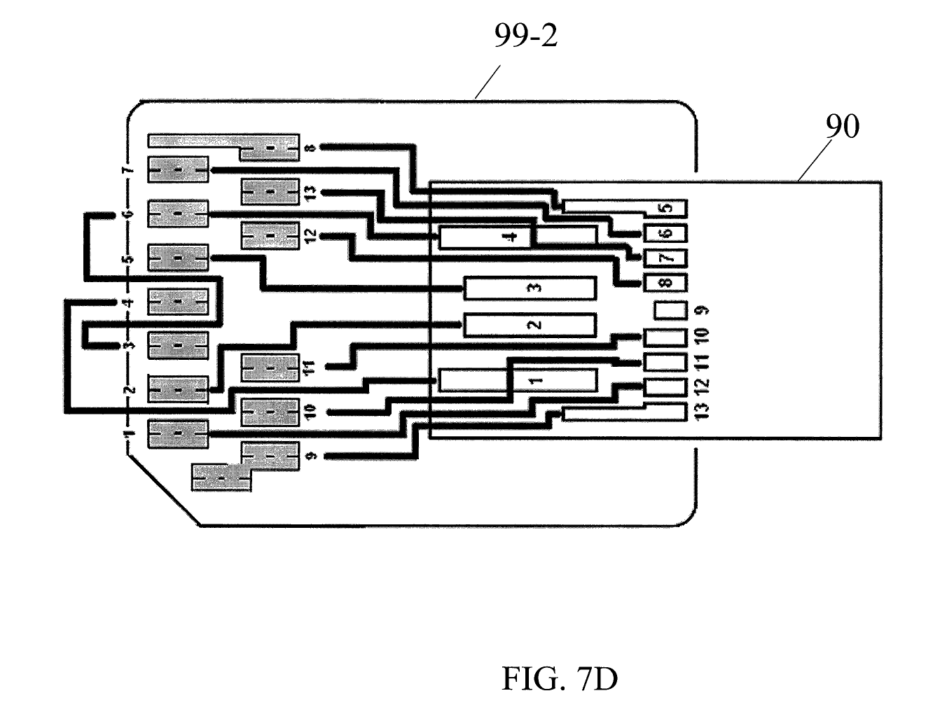

FIG. 7A is a diagram of an electrical interface device 90 in accordance with one embodiment of the present invention. Referring to FIG. 7A, electrical interface device 90 includes an electronic card 91 and a carrier 92 into which the electronic card 91 is housed. Electronic card 91 provides substantially the same functions as the electrical interface devices illustrated in the previously discussed embodiments. Carrier 92 includes, but not limited to, a plastic passive component. In one embodiment, electrical interface device 90 or carrier 92 has a thickness “d” of approximately 1 mm (millimeter), which is suitable for use with small consumer electronics. Alternatively, electrical interface device 90 or carrier 92 has a thickness “d” of approximately 2 mm (millimeter), which is suitable for use with a USB Standard-A receptacle.

FIG. 7B is a diagram of an electrical interface device 95 in accordance with another embodiment of the present invention. Referring to FIG. 7B, electrical interface device 95 includes an electronic card 96 and a carrier 97. Carrier 97 includes a first guide trench 98-1 extending substantially in parallel with a first side 97-1 of carrier 97. With first guide trench 98-1, carrier 97 may include a more compact holder (not shown) at a host-side connector (not shown) for receiving electrical interface device 95 in a direction labeled as “D,” as compared to carrier 92 illustrated in FIG. 7A, having the same thickness d. Carrier 97 may further include a second guide trench 98-2 extending substantially in parallel with a second side 97-2 of carrier 97, which further facilitates the compactness of the holder.

FIG. 7C is a diagram of an adapter 99-1 for use with electrical interface device 90 illustrated in FIG. 7A in accordance with one embodiment of the present invention. Referring to FIG. 7C, adapter 99-1 is capable of receiving electrical interface device 90. Adapter 99-1 is electrically connected to electrical interface device 90 through conductive lines 93 and functions to serve as an MMC card or SD card once electrical interface device 90 is inserted thereto. In the present embodiment, adapter 99-1 supports 4-bit MMC or SD connection. Specifically, also referring to the pin assignment chart illustrated in FIG. 6B, each of the four pins 5, 6, 12 and 13 of the second pad row of electrical interface device 90 for MMC or non-USB connection is electrically connected to a corresponding pad of adapter 99-1.

FIG. 7C shows an example that the adapter 99-1 suitable for use with electrical interface device 90. One skilled in the art will recognize that adapter 99-1 is also suitable with electrical interface device 95 illustrated in FIG. 7B. In that case, adapter 99-1 may be made with a slimmer profile.

FIG. 7D is a diagram of an adapter 99-2 for use with electrical interface device 90 illustrated in FIG. 7A in accordance with another embodiment of the present invention. Referring to FIG. 7D, the adapter 99-2 supports 8-bit MMC connection. Specifically, also referring to FIG. 6B, each of the eight pins 5 to 8 and 10 to 13 of the second pad row of electrical interface device 90 for MMC or non-USB connection is electrically connected to a corresponding pad of adapter 99-2. Alternatively, adapter 99-2 is suitable with electrical interface device 95 illustrated in FIG. 7B. In that case, adapter 99-2 may be made with a slim profile.

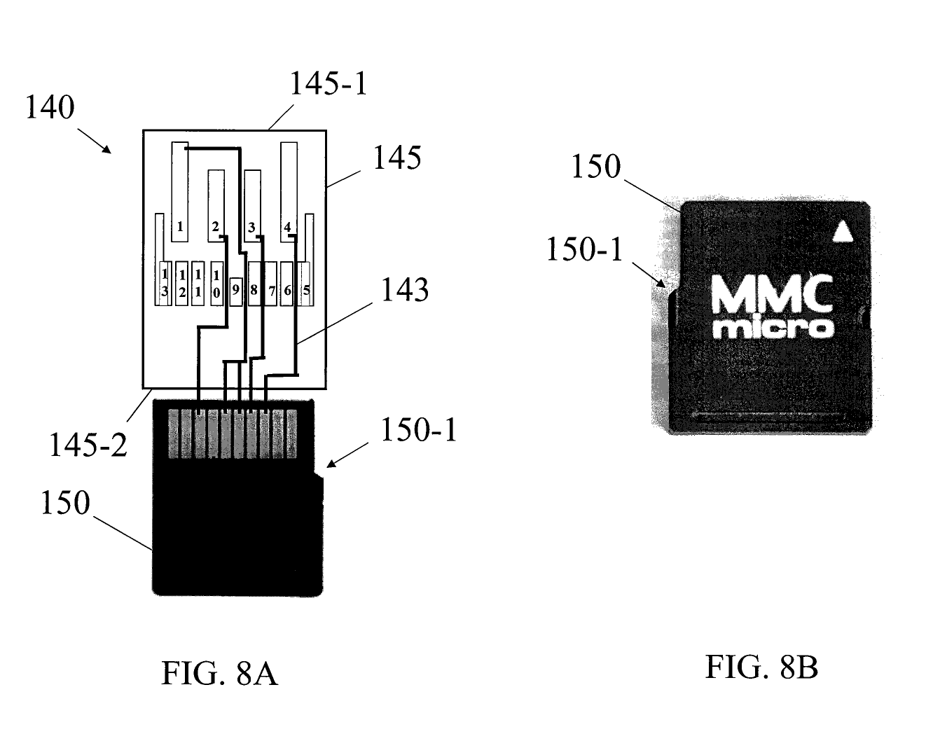

FIG. 8A is a schematic diagram of an electrical interface device 140 in accordance with one embodiment of the present invention. Referring to FIG. 8A, electrical interface device 140 includes an adapter 145 further including a first row of pins numbered 1 to 4 and a second row of pins numbered 5 to 13. The pin assignment and pin arrangement of the pins 1 to 13 of the adapter 145 are similar to those of the electrical interface device 86 illustrated in FIG. 6A and therefore will not be repeated herein. Adapter 145 further includes a first end 145-1 connectible to or removable from a host, and a second side 145-2 for receiving a micro memory card 150. Micro memory card 150, when inserted into adapter 145, is electrically connected to the first and second rows of pins of adapter 145. For simplicity, only conductive lines 143 for establishing electrical connections between the first row of pins 1 to 4 and the micro memory card 150 are illustrated. To prevent incorrect insertion to electrical interface device 140, micro memory card 150 includes an indentation 150-1 on the peripheral thereof.

FIG. 8B is a schematic top elevational view of micro memory card 150 suitable for use with electrical interface device 140 illustrated in FIG. 8A. Referring to FIG. 8B, micro memory card 150 includes an MMC micro memory card or a micro SD memory card. The MMC micro memory card refers to an MMC-compatible card that supports MMC 4.0 applications and is backward compatibility with existing MMC protocols. The MMC micro memory card is a relatively small in size, approximately one-fourth the size of a full-size MMC card, and is tailored to fit the increasingly shrinking camera phones. The micro SD memory card refers to an SD-compatible flash memory card, approximately one-fourth the size of a full-size SD card. Micro SD memory cards are generally used in mobile phones, handheld global positioning system (“GPS”) devices and portable audio players.

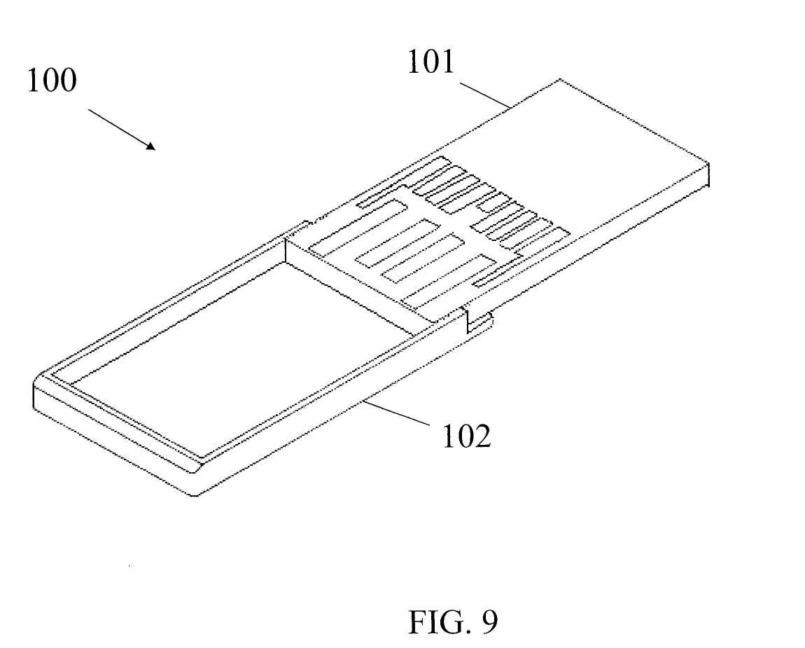

FIG. 9 is a diagram of an electrical interface device 100 in accordance with another embodiment of the present invention. Referring to FIG. 9, electrical interface device 100 includes an electronic card 101 and a carrier 102. Electronic card 101 is slidably movable with respect to carrier 102. Depending on actual applications, the thickness of carrier 102 may vary from 1 mm to 2 mm.

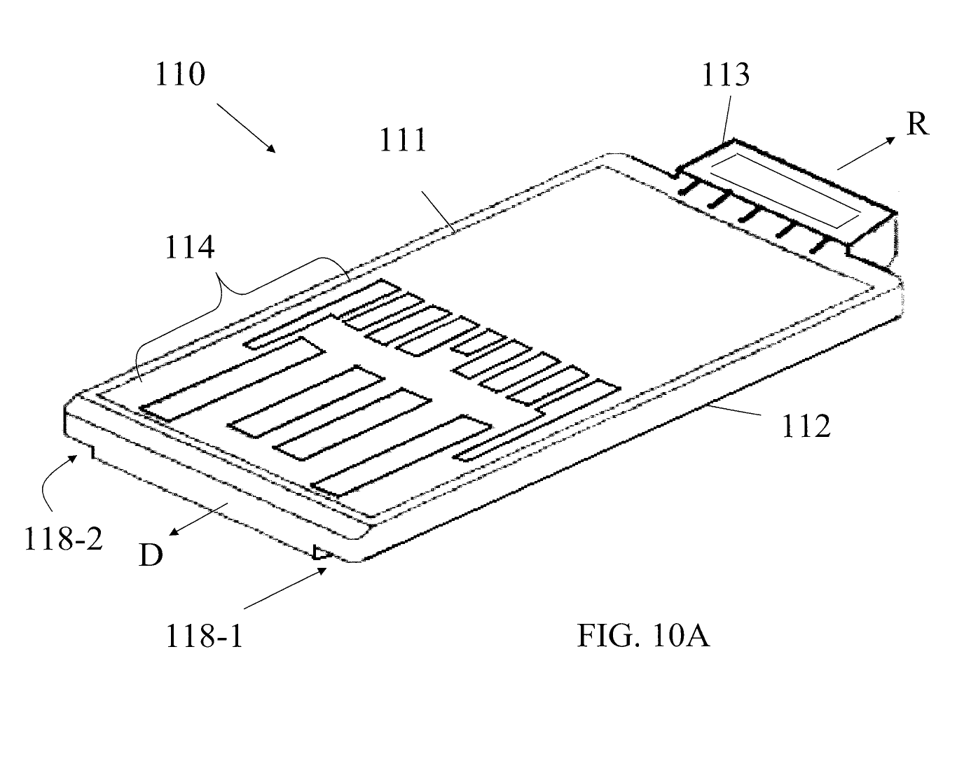

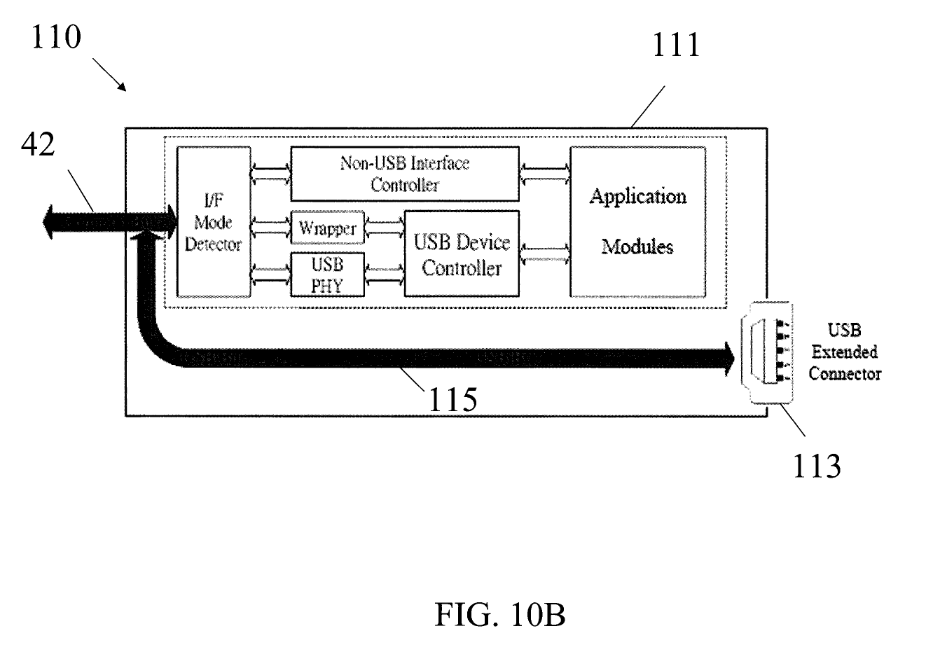

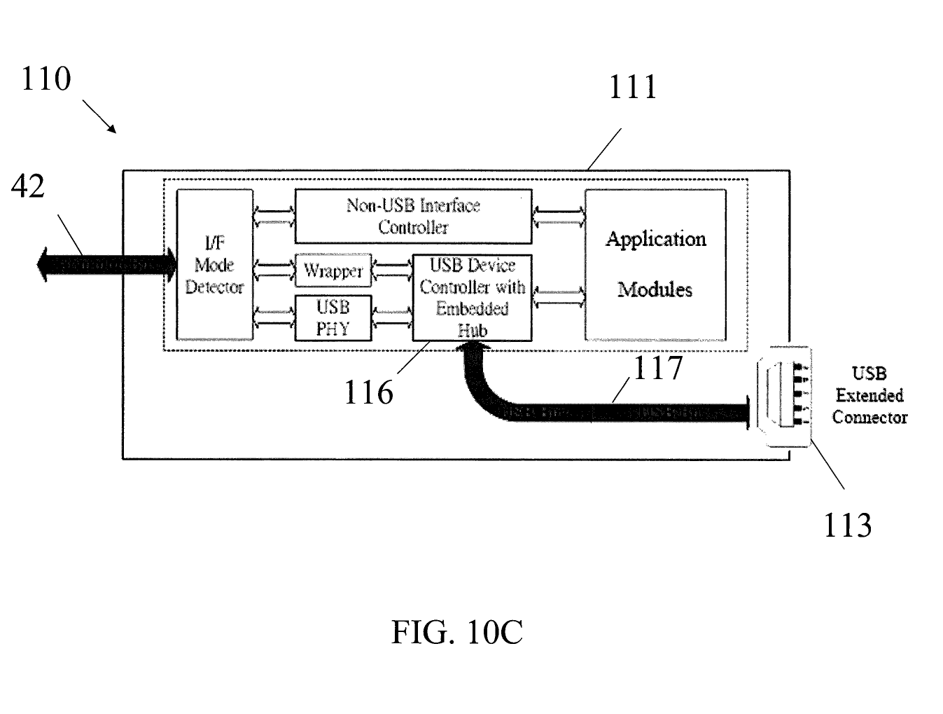

FIG. 10A is a diagram of an electrical interface device 110 in accordance with still another embodiment of the present invention. Referring to FIG. 10A, electrical interface device 110 includes an electronic card 111, a carrier 112 for supporting the electronic card 111, a first connector 114 and a second connector 113. First connector 114, including a first and a second row of contact pads, serves as a first interface for the USB Standard-A connection. Second connector 113, for example, a Mini USB connector, serves as a second interface for extended USB connection for electrical interface device 110. The Mini USB connector includes a smaller USB plug or receptacle, and is generally classified as Mini-A and Mini-B, which are specified by the On-The-Go Supplement to the USB 2.0 Specification (USB OTG).

Carrier 112 includes a first guide trench 118-1 extending substantially in parallel with an insertion direction, shown as “D” of first connector 114 or an insertion direction “R” of the second connector 113. As has been previously discussed with respect to FIG. 7B, first guide trench 118-1 facilitates the compactness of the holder or receptacle. Carrier 112 may further include a second guide trench 118-2 extending substantially in parallel with the insertion direction D or R, to further facilitate the compactness of the holder or receptacle.

FIGS. 10B and 10C are functional block diagrams of electrical interface device 110 illustrated in FIG. 10A. Referring to FIG. 10B, extended USB connector 113 bypasses USB-compatible signals to common bus 42 over a USB bus 115. Alternatively, referring to FIG. 10C, electrical interface device 110 includes a USB device controller 116 further comprising an embedded USB hub for receiving USB-compatible signals from second connector 113 over a USB bus 117.

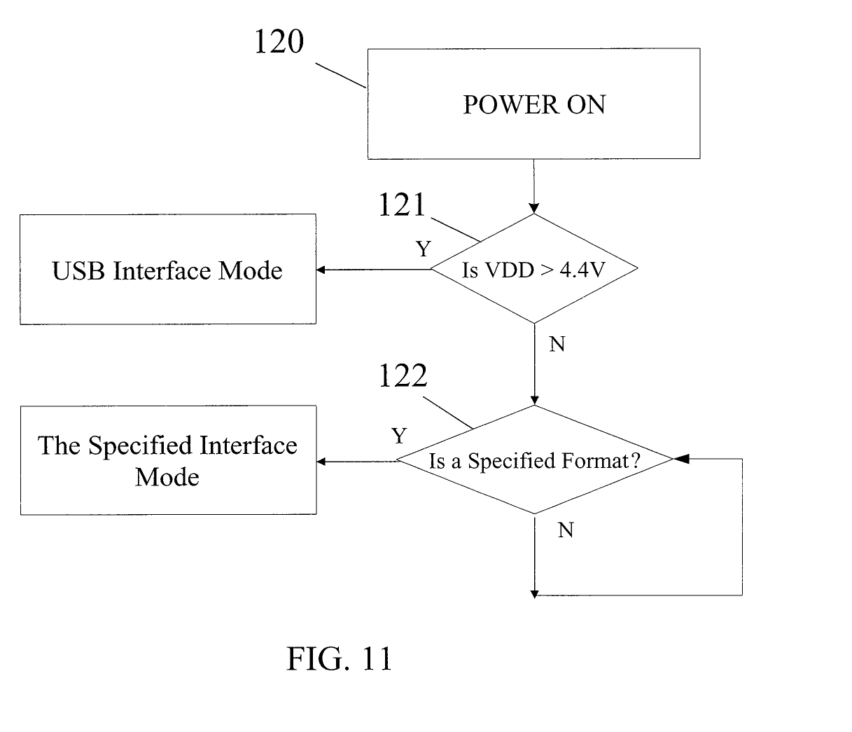

FIG. 11 is a flow diagram illustrating a method for interface mode detection on the device side. Referring to FIG. 11, a host to which an electrical interface device according to the present invention is connected is turned on at step 120. The power source voltage VDD at the host side is detected at step 121 to determine whether the VDD is equal to or greater than a voltage level a USB application requires. Normally, for USB signaling, the voltage level ranges from approximately 4.5V (volts) to 5.5V, while a non-USB application or a Mu application is operated at a voltage level of approximately 1.8V or 3.3V. At step 121, if the VDD level at the host side is equal to or greater than 4.4V, it is determined that the mode of operation is a USB application, for example, the USB 2.0. If the VDD level at the host side is smaller than 4.4V, at step 122, it is determined that the mode of operation is either a Mu application or a non-USB application, depending on a specified format, for example, a flag sent from the host.

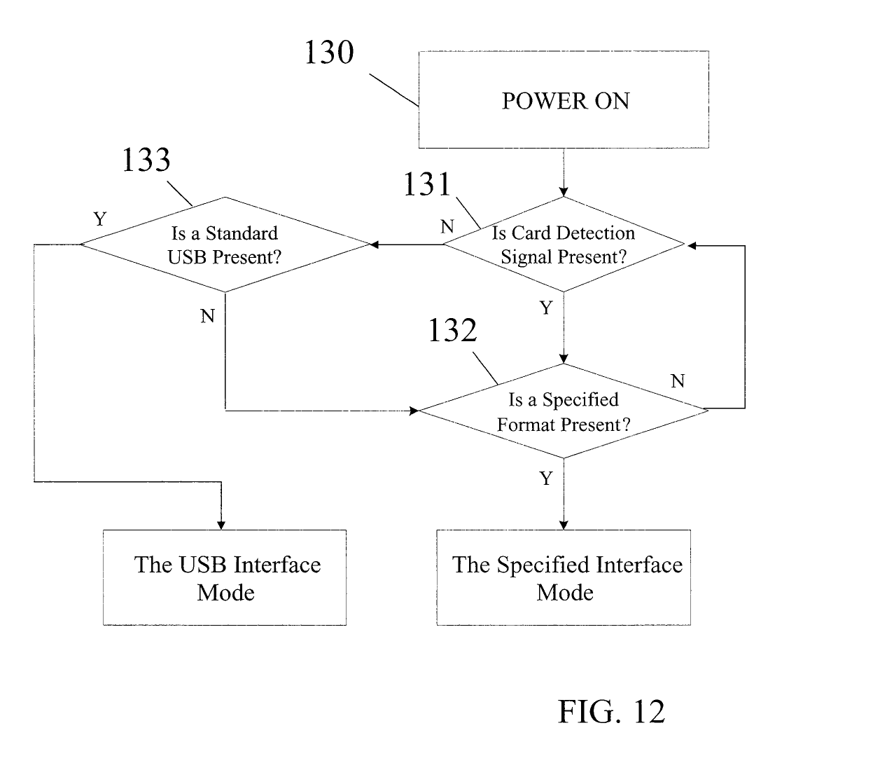

FIG. 12 is a flow diagram illustrating a method for interface mode detection at a host side. Referring to FIG. 12, the host is turned on at step 130. Next, at step 131, it is determined whether a Card-Detect signal is detected. The Card-Detect signal is present at pin numbered 13 illustrated in FIG. 4B or pin numbered 10 illustrated in FIG. 6B. In response to the Card-Detection signal, which means that an electrical interface device according to the present invention is in use, at step 132, it is determined that the mode of operation is either a Mu application or a non-USB application, depending on a specified format. The electrical interface device operates at the Mu mode if the specified format includes a Mu format and is responded by the electrical interface device. The electrical interface device operates in the non-USB mode if the specified format includes a format different from the Mu format and is responded by the electrical interface device. If the Card-Detect signal is not present, at step 133, it is determined whether the electrical interface device supports standard USB. If confirmative, the host determines that the electrical interface device operates in USB mode. Otherwise, it is determined that the mode of operation is either a Mu application or a non-USB application, depending on a specified format.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. A removable electrical interface device for transferring data to and from a host adapted to operate in one of a universal serial bus (USB) compatible mode, a Mu mode and a non-USB compatible mode, comprising:
a first row of contact pads capable of supporting at least one of USB Standard-A connection, Mu mode connection, or non-USB compatible mode connection; and
a second row of contact pads capable of supporting at least one of the Mu mode connection or the non-USB compatible mode connection.

2. The device of claim 1, wherein the first row of contact pads is connectible to or removable from a USB Standard-A receptacle of the host.

3. The device of claim 1, wherein the first row of contact pads are disposed near a first side of the removable electrical interface device in an insertion direction towards the host, and the second row of contact pads are disposed closer to the first row of contact pads than a second side of the removable electrical interface device in the insertion direction.

4. The device of claim 1, wherein the first row of contact pads are disposed near a first side of the removable electrical interface device in an insertion direction towards the host, and the second row of contact pads are disposed near a second side of the removable electrical interface device in the insertion direction.

5. The device of claim 1, further comprising a notch formed in a corner of the removable electric interface device.

6. The device of claim 1, wherein one of the first row of contact pads is disposed farther to the first side than the other of the first row of contact pads to facilitate card detection.

7. The device of claim 1, wherein one of the second row of contact pads is disposed farther to the first side than the other of the second row of contact pads to facilitate card detection.

8. The device of claim 1, wherein at least one of the second row of contact pads extends in an insertion direction towards the host to exceed one end of at least one of the first row of contact pads.

9. A removable electrical interface device for transferring data to and from a host adapted to operate in one of a universal serial bus (USB) compatible mode, a Mu mode and a non-USB compatible mode, comprising:
an electrical card further comprising:
a first row of contact pads capable of supporting at least one of USB Standard-A connection, Mu mode connection or non-USB compatible mode connection; and
a second row of contact pads capable of supporting at least one of the Mu mode connection or the non-USB compatible mode connection; and
a carrier for supporting the electrical card.

10. The device of claim 9, wherein the first row of contact pads are connectible to or removable from a USB Standard-A receptacle of the host.

11. The device of claim 9, wherein the carrier is suitable for use with one of a USB Standard-A receptacle and an electronic device having a receptacle width smaller than the USB Standard-A receptacle.

12. The device of claim 9, wherein the carrier includes at least one guide trench extending substantially in parallel with an insertion direction of the carrier.

13. The device of claim 9, further comprising a connector capable of providing extended-USB connection.

14. The device of claim 13, wherein the connector includes a Mini USB connector.

15. The device of claim 9, wherein the first row of contact pads are disposed near a first side of the removable electrical interface device in an insertion direction towards the host, and the second row of contact pads are disposed closer to the first row of contact pads than a second side of the removable electrical interface device in the insertion direction.

16. The device of claim 9, wherein the first row of contact pads are disposed near a first side of the removable electrical interface device in an insertion direction towards the host, and the second row of contact pads are disposed near a second side of the removable electrical interface device in the insertion direction.

17. The device of claim 9, wherein one of the second row of contact pads is disposed farther to the first side than the other of the second row of contact pads.

18. The device of claim 9, further comprising an adapter capable of receiving the electrical card and the carrier.

19. The device of claim 18, the adapter supports one of 4-bit MMC connection and 8-bit MMC connection.

20. The device of claim 18, the adapter supports one of 4-bit MMC connection and 4-bit SD connection.

21. A removable electrical interface device for transferring data to and from a host adapted to operate in one of a universal serial bus (USB) compatible mode, a Mu mode and a non-USB compatible mode, comprising:
an adapter further comprising:
a first row of contact pads capable of supporting at least one of USB Standard-A connection, Mu mode connection or non-USB compatible mode connection; and
a second row of contact pads capable of supporting at least one of the Mu mode connection or the non-USB compatible mode connection;
a first terminal being connectible to or removable from a USB Standard-A receptacle of the host; and
a second terminal capable of receiving a memory card.

22. The device of claim 21, wherein the memory card includes one of an MMC micro memory card and a micro SD memory card.

23. The device of claim 21, wherein the memory card includes an indentation on a peripheral thereof.
